(19) United States
(12) Patent Application Publication
(10) Pub. No.: US 2019/0155700 A1
(43) Pub. Date: May 23, 2019

(54) MEMORY SYSTEM AND METHOD OF OPERATING THE SAME

(71) Applicant: SK hynix Inc., Gyeonggi-do (KR)

(72) Inventors: Young Ho KIM, Gyeonggi-do (KR); Ik Joon SON, Gyeonggi-do (KR); Yong Sang LEE, Gyeonggi-do (KR); Seung Gu JI, Seoul (KR)

(21) Appl. No.: 16/007,432

(22) Filed: Jun. 13, 2018

(30) Foreign Application Priority Data
Nov. 17, 2017 (KR) 10-2017-0154220

(51) Int. Cl. G06F 11/14; G06F 3/06

(52) U.S. Cl. CPC G06F 11/1469; G06F 3/0619; G06F 3/0652; G06F 2201/82; G06F 11/1451; G06F 3/064; G06F 3/0679

(57) ABSTRACT

Provided herein is a memory system and a method for driving the memory system. The memory system may include: a semiconductor memory device including a plurality of memory blocks and a block information storing block; and a controller configured to control the semiconductor memory device to store block information about the memory blocks into the block information storing block during an overall operation of the semiconductor memory device, and perform, during a power loss recovery operation, a recovery operation using the block information stored in the block information storing block.

### CROSS-REFERENCE TO RELATED APPLICATION

The present application claims priority under 35 U.S.C. § 119(a) to Korean patent application number 10-2017-0154220, filed on Nov. 17, 2017, which is incorporated herein by reference in its entirety.

### BACKGROUND

### 1. Field of Invention

Various embodiments of the present disclosure generally relate to a memory system and a method of operating the memory system, and more particularly, to a memory system configured to perform a power loss recovery operation, and a method of operating the memory system.

### 2. Description of Related Art

Recently, the paradigm for the computer environment has been converted into ubiquitous computing so that computer systems can be used anytime and anywhere. Thereby, the use of portable electronic devices such as mobile phones, digital cameras, and notebook computers has rapidly increased. In general, such portable electronic devices use a memory system which employs a memory device, in other words, use a data storage device. The data storage device is used as a main memory device or an auxiliary memory device of the portable electronic devices.

A data storage device using a memory device provides advantages in that, since there is no mechanical driving part, stability and durability are excellent, an information access speed is increased, and power consumption is reduced. Examples of a data storage device proposed as the memory system having such advantages may include a universal serial bus (USB) memory device, a memory card having various interfaces, and a solid state drive (SSD).

### SUMMARY

Various embodiments of the present disclosure are directed to a memory system capable of performing an efficient power loss recovery operation, and a method of operating the memory system.

An embodiment of the present disclosure may provide for a memory system including: a semiconductor memory device including a plurality of memory blocks and a block information storing block; and a controller configured to : control the semiconductor memory device to store block information about the memory blocks into the block information storing block during an overall operation of the semiconductor memory device, and perform, during a power loss recovery operation, a recovery operation using the block information stored in the block information storing block.

An embodiment of the present disclosure may provide for a memory system including: a semiconductor memory device including a plurality of memory blocks and a block information storing block; and a controller configured to control the semiconductor memory device to store block information about the memory blocks into the block information storing block at each of status update points at which statuses of the memory blocks are changed during an overall operation of the semiconductor memory device.

An embodiment of the present disclosure may provide for a memory system including: a memory device including a plurality of data blocks and two or more information blocks; and a controller suitable for: controlling the memory device to store information about a status of the data blocks, a currently selected data block, a most recently used data block, a data block to be used subsequent to the currently selected data block, and a garbage collection victim block alternately into each of the information blocks according to their storage size at each time a status of any one among the data blocks changes; and performing a power loss recovery operation by using the information stored in a most recently used one among the information blocks.

An embodiment of the present disclosure may provide for a method of operating a memory system, including: performing an overall operation including a read operation, a write operation, and an erase operation of a semiconductor memory device including a plurality of memory blocks and a block information storing block; updating and storing block information into the block information storing block at each of status update points during the overall operation; reading latest block information stored in the block information storing block when a power-on operation is performed after a power loss; and performing a power loss recovery operation using the read latest block information.

### BRIEF DESCRIPTION OF THE DRAWINGS

FIG. 1 is a block diagram illustrating a memory system in accordance with an embodiment of the present disclosure.

FIG. 2 is a block diagram illustrating a semiconductor memory device of FIG. 1.

FIG. 3 is a block diagram illustrating an embodiment of a memory cell array of FIG. 2.

FIG. 4 is a circuit diagram illustrating a memory block shown in FIG. 3.

FIGS. 5 and 6 are flowcharts illustrating a method of operating a memory system in accordance with an embodiment of the present disclosure.

FIG. 7 is a diagram illustrating a block information table in accordance with an embodiment of the present disclosure.

FIG. 8 is a block diagram illustrating an example of application of the memory system of FIG. 1.

FIG. 9 is a block diagram illustrating a computing system including the memory system described with reference to FIG. 8.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present.

Hereinafter, embodiments will be described with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as “first” and “second” may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, “and/or” may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

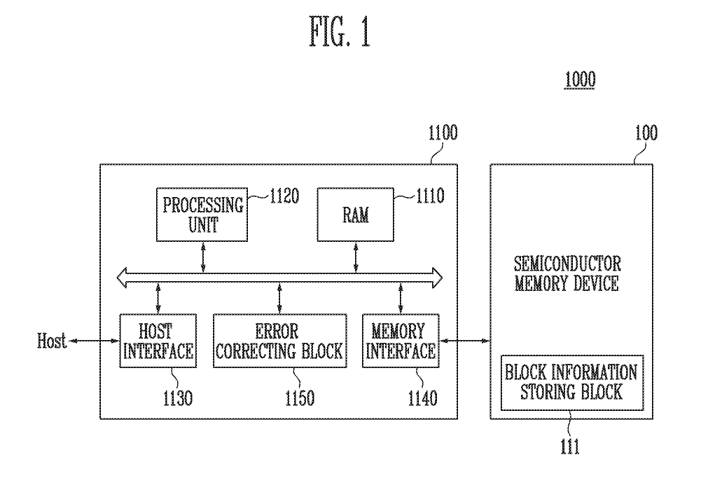

FIG. 1 is a block diagram illustrating a memory system 1000 in accordance with an embodiment of the present disclosure.

Referring FIG. 1, the memory system 1000 may include a semiconductor memory device 100 and a controller 1100.

The semiconductor memory device 100 may perform operations such as a read operation, a write operation, an erase operation, and a background operation under control of the controller 1100. The semiconductor memory device 10 may include a plurality of memory blocks. At least two or more memory blocks among the plurality of memory blocks may be formed of block information storing blocks 111. The semiconductor memory device 100 may store status information about each of the memory blocks into the block information storing block 111 at a status update point during an overall operation such as a read operation, a write operation, an erase operation, and a background operation. Furthermore, after power is resupplied after an abnormal powerloss has occurred, the semiconductor memory device 100 may output the latest data among the data stored in the block information storing block 111, to the controller 1100.

The controller 1100 is coupled to a host Host and the semiconductor memory device 100. The controller 1100 may access the semiconductor memory device 100 in response to a request from the host Host. For example, the controller 1100 may control a read operation, a write operation, an erase operation, and a background operation of the semiconductor memory device 100. The controller 1100 may provide an interface between the host Host and the semiconductor memory device 100. The controller 1100 may drive firmware for controlling the semiconductor memory device 100.

In accordance with an embodiment of the present disclosure, the controller 110 may control the semiconductor memory device 100 such that when operations such as a read operation, a write operation, an erase operation, and a background operation of the semiconductor memory device 100 are performed, information about the memory blocks included in the semiconductor memory device 100 is stored into the block information storing block 111 at the status update point. The status update point may be a point in time at which a new memory block is allocated or a point in time at which a new memory block is used, during the overall operation such as the read operation, the write operation, the erase operation, and the background operation of the semiconductor memory device 100. The above-mentioned point in time at which a new memory block is allocated, or the point in time at which a new memory block is used may be a point in time at which the statuses of the memory blocks change during the overall operation, and be suitable for updating status information about the memory blocks, statuses of which are most recently changed.

During a booting process by resupplying power after an abnormal power loss has occurred, the controller 1100 may perform a power loss recovery operation for recovering the memory system 1000 from the power loss. For example, the controller 1100 may rapidly perform the recovery operation using the information about the memory blocks stored in the semiconductor memory device 100.

The controller 1100 may include a random access memory (RAM) 1110, a processing unit 1120, a host interface 1130, a memory interface 1140, and an error correcting block 1150.

The RAM 1110 may store firmware therein and be used as an operating memory for the processing unit 1120, a cache memory between the semiconductor memory device 100 and the host Host, and a buffer memory between the semiconductor memory device 100 and the host Host. The firmware may include an algorithm for performing the overall operation. The RAM 1110 may store data to be processed by the controller 1100. The RAM 1110 may store valid data needed to control the overall operation of the semiconductor memory device 100. For instance, the RAM 1110 may store address mapping information, information about a current open block, victim block information, free block information, valid data storing block information, information about a block to be erased, and so forth.

The processing unit 1120 may control the overall operation of the controller 1100, and control a program operation, a read operation, or an erase operation of the semiconductor memory device 100. In an embodiment of the present disclosure, the processing unit 1120 may control the semiconductor memory device 100 to program information about each of the memory blocks included in the semiconductor memory device 100 into the block information storing block 111 at the status update point during the overall operation of the semiconductor memory device 100. Furthermore, during the booting process by resupplying power after the abnormal power loss has occurred, the processing unit 1120 may perform the power loss recovery operation using the information about each of the memory blocks stored in the block information storing block 111.

The host interface 1130 may include a protocol for performing data exchange between the host Host and the controller 1100. In an embodiment, the controller 1200 may communicate with the host Host through at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol, and a private protocol.

The memory interface 1140 may interface with the semiconductor memory device 100. For example, the memory interface may include a NAND interface or a NOR interface.

The error correcting block 1150 may use an error correcting code (ECC) to detect and correct an error in data received from the semiconductor memory device 100. For example, the error correction block 1150 may compare the number of bits of the detected error with the maximum allowed number of ECC bits and correct the detected error when the number of bits of the detected error is less than the maximum allowed number of ECC bits.

The controller 1100 and the semiconductor memory device 100 may be integrated into a single semiconductor device. In an embodiment, the controller 1100 and the semiconductor memory device 100 may be integrated into a single semiconductor device to form a memory card. For example, the controller 1100 and the semiconductor memory device 100 may be integrated into a single semiconductor device and form a memory card such as a personal computer memory card international association (PCMCIA), a compact flash card (CF), a smart media card (SM or SMC), a memory stick multimedia card (MMC, RS-MMC, or MMCmicro), a SD card (SD, miniSD, microSD, or SDHC), and a universal flash storage (UFS).

The controller 1100 and the semiconductor memory device 100 may be integrated into a single semiconductor device to form a solid state drive (SSD). The SSD may include a storage device configured to store data into a semiconductor memory. When the memory system 1000 is used as the SSD, the operating speed of the host Host coupled to the is memory system 2000 may be phenomenally improved.

In an embodiment, the memory system 1000 may be provided as one of various elements of an electronic device such as a computer, a ultra mobile PC (UMPC), a workstation, a net-book, a personal digital assistant (PDA), a portable computer, a web tablet, a wireless phone, a mobile phone, a smart phone, an e-book, a portable multimedia player (PMP), a game console, a navigation device, a black box, a digital camera, a 3-dimensional television, a digital audio recorder, a digital audio player, a digital picture recorder, a digital picture player, a digital video recorder, a digital video player, a device capable of transmitting/receiving information in an wireless environment, one of various devices for forming a home network, one of various electronic devices for forming a computer network, one of various electronic devices for forming a telematics network, an RFID device, one of various elements for forming a computing system, or the like.

In an embodiment, the semiconductor memory device 100 or the memory system 1000 may be embedded in various types of packages. For example, the semiconductor memory device 100 or the memory system 1000 may be packaged in a type such as Package on Package (PoP), Ball grid arrays (BGAs), Chip scale packages (CSPs), Plastic Leaded Chip Carrier (PLCC), Plastic Dual In Line Package (PDIP), Die in Waffle Pack, Die in Wafer Form, Chip On Board (COB), Ceramic Dual In Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), or Wafer-Level Processed Stack Package (WSP).

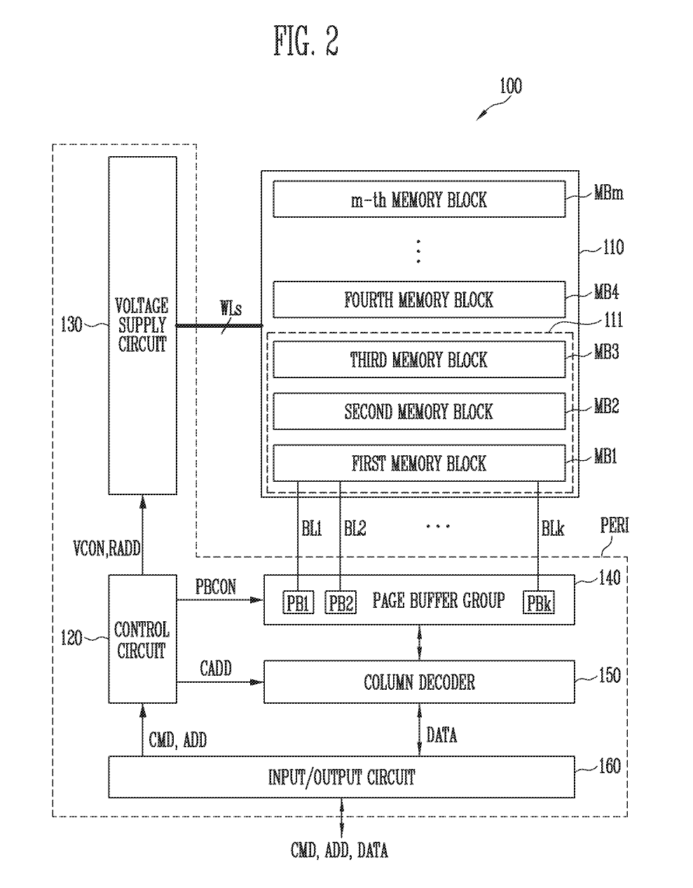

FIG. 2 is a block diagram illustrating the semiconductor memory device 100 shown in FIG. 1.

Referring to FIG. 2, the semiconductor memory device 100 in accordance with an embodiment of the present disclosure may include a memory cell array 110 including first to m-th memory blocks MB1 to MBm, and a peripheral circuit PERI configured to perform a program operation and a read operation on memory cells included in a selected page of the memory blocks MB1 to MBm. The peripheral circuit PERI may include a control circuit 120, a voltage supply circuit 130, a page buffer group 140, a column decoder 150, and an input/output circuit 160.

Among the first to m-th memory blocks MB1 to MBm included in the memory cell array 110, some memory blocks may be defined as the block information storing block 111. The block information storing block 111 may include at least two or more memory blocks (e.g., MB1 and MB2). The memory block MB1 may update and store information about memory blocks (e.g., MB4 to MBm) at each status update point. If the first memory block MB1 lacks storage space, information about the memory blocks that is updated at each status update point may be stored into the second memory block MB2. When the information about the memory blocks are stored into the second memory block MB2, the first memory block MB1 may be erased. If the second memory block MB2 lacks storage space, information about the memory blocks that is updated at each status update point may be stored into the first memory block MB1, and the second memory block MB2 may be erased. The block information storing block 111 may further include an additional backup memory block MB3. The backup memory block MB3 may backup and store the information about the memory blocks that have been stored in the first memory block MB1 or the second memory block MB2. Each of the first to third memory blocks MB1 to MB3 included in the block information storing block 111 may be used as single level cells. Thereby, the reliability of data stored into the first to third memory blocks MB1 to MB3 may be secured, and the speed of data program/read operation of the block information storing block 111 may be enhanced.

The controller circuit 120 may output a voltage control signal VCON for generating a voltage needed to perform a program operation or a read operation in response to a command CMD input from an external device through the input/output circuit 160, and output a PB control signal PBCON for controlling page buffers PB1 to PBk included in the page buffer group 140 depending on the type of operation. Furthermore, the control circuit 120 may output a row address signal RADD and a column address signal CADD in response to an address signal ADD input from the external device through the input/output circuit 160.

The voltage supply circuit 130 may supply operating voltages needed for a program operation, a read operation, and an erase operation of memory cells to local lines of the selected memory block including a drain select line, word lines WLs, and a source select line, in response to a voltage control signal VCON of the control circuit 120. The voltage supply circuit 130 may include a voltage generating circuit and a row decoder.

The voltage generating circuit may output the operating voltages needed for the program operation, the read operation, or the erase operation of the memory cells to global lines, in response to the voltage control signal VCON of the control circuit 120.

The row decoder may couple, in response to row address signals RADD of the control circuit 120, the global lines to the local lines such that the operating voltages output from the voltage generating circuit to the global lines may be transmitted to the local lines of the selected memory block in the memory cell array 110.

The page buffer group 140 includes a plurality of page buffers PB1 to PBk coupled with the memory cell array 110 through bit lines BL1 to BLk. In response to a PB control signal PBCON of the control circuit 120, the page buffers PB1 to PBk of the page buffer group 140 may selectively precharge the bit lines BL1 to BLk depending on input data so as to store the data into the memory cells, or sense voltages of the bit lines BL1 to BLk so as to read out data from the memory cells.

The column decoder 150 may select the page buffers PB1 to PBk included in the page buffer group 140 in response to a column address signal CADD output from the control circuit 120. In other words, the column decoder 150 may successively transmit data to be stored into the memory cells, to the page buffers PB1 to PBk in response to the column address signal CADD. Furthermore, during a read operation, the column decoder 150 may successively select the page buffers PB1 to PBk in response to a column address signal CADD such that data of memory cells latched in the page buffers PB1 to PBk may be output to the external device.

During a program operation, the input/output circuit 160 may transmit data input from the external device to store the data into the memory cells, to the column decoder 150 under control of the control circuit 120 so that the data may be input to the page buffer group 140. When the column decoder 150 transmits the data transmitted from the input/output circuit 160 to the page buffers PB1 to PBk of the page buffer group 140, the page buffers PB1 to PBk may store the input data into internal latch circuits thereof. During a read operation, the input/output circuit 160 may output, to the external device, data transmitted from the page buffers PB1 to PBk of the page buffer group 140 through the column decoder 150.

The peripheral circuit PERI of the semiconductor memory device 100 in accordance with an embodiment of the present disclosure may store information about each of the memory blocks into the block information storing block 111 at the status update point during the overall operation such as a read operation, a write operation, an erase operation, and a background operation of the semiconductor memory device 100 under control of the controller 1100 of FIG. 1 The status update point may be a point in time at which a new memory block is allocated or a point in time at which a new memory block is used, during the overall operation such as the read operation, the write operation, the erase operation, and the background operation of the semiconductor memory device 100.

Furthermore, after power is resupplied after a power loss has occurred, the semiconductor memory device 100 may output the latest data among the data stored in the block information storing block 111, to the controller 1100. The latest data may be data stored in a most recently programmed page of the first memory block MB1 or the second memory block MB2 included in the block information storing block 111.

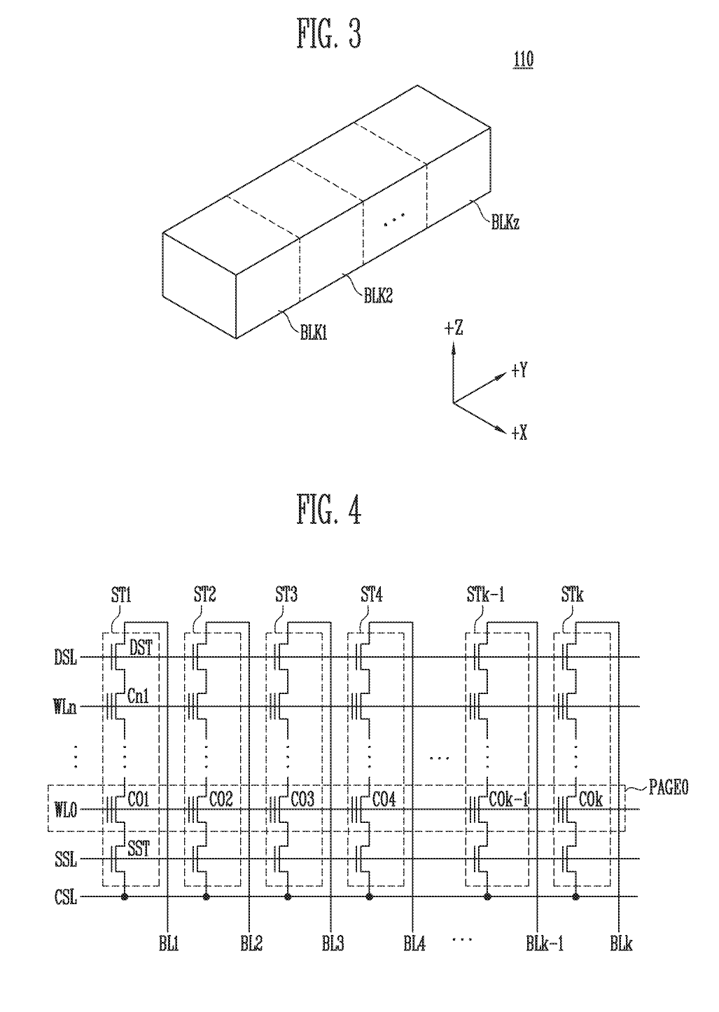

FIG. 3 is a block diagram illustrating an example of the memory cell array 110 of FIG. 2.

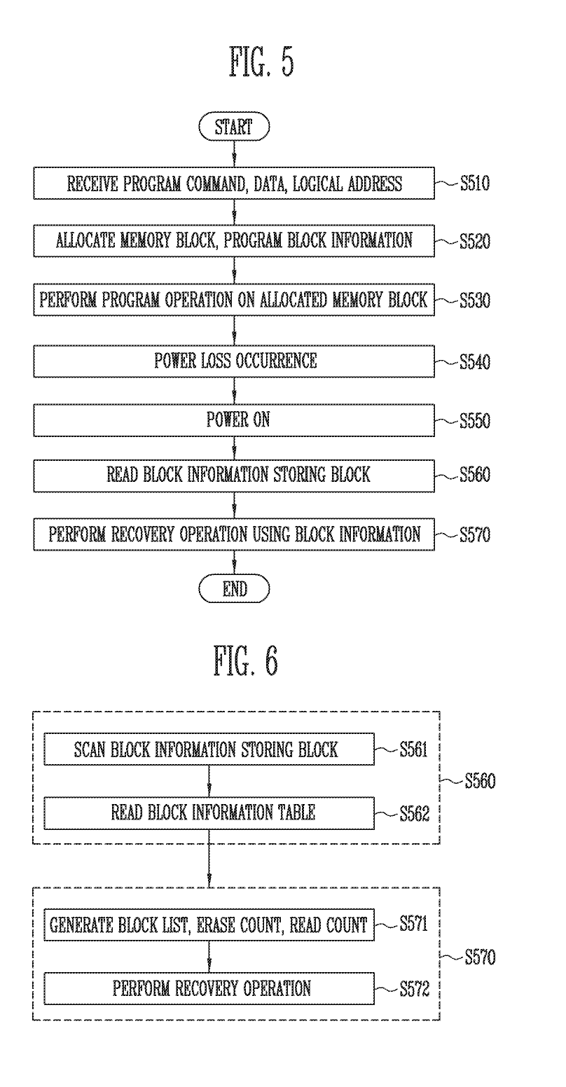

Referring to FIG. 3, the memory cell array 110 may include a plurality of memory blocks BLK1 to BLKz. Each memory block has a three-dimensional structure. Each memory block may include a plurality of memory cells stacked on a substrate. The memory cells are arranged in a +X direction, a +Y direction, and a +Z direction. The structure of each memory block will be described in more detail with reference to FIG. 4.

FIG. 4 is a circuit diagram illustrating a memory block shown in FIG. 3.

Referring to FIG. 4, each memory block may include a plurality of strings ST1 to STk coupled between the bit lines BL1 to BLk and a common source line CSL. In other words, the strings ST1 to STk may be respectively coupled with the bit lines BL1 to BLk and coupled in common with the common source line CSL. Each string, e.g., ST1, may include a source select transistor SST having a source coupled to the common source line CSL, a plurality of memory cells C01 to Cn1, and a drain select transistor DST having a drain coupled to the bit line BL1. The memory cells C01 to Cn1 may be coupled in series between the select transistors SST and DST. A gate of the source select transistor SST may be coupled to the source select line SSL. Gates of the memory cells C01 to Cn1 may be respectively coupled to the word lines WL0 to WLn. A gate of the drain select transistor DST may be coupled to the drain select line DSL.

The memory cells included in the memory block may be divided on a physical page basis or on a logical page basis. For example, memory cells C01 to C0k coupled to a single word line (e.g., WL0) may form a single physical page PAGE0. Each of the pages may be the basic unit of a program operation or a read operation.

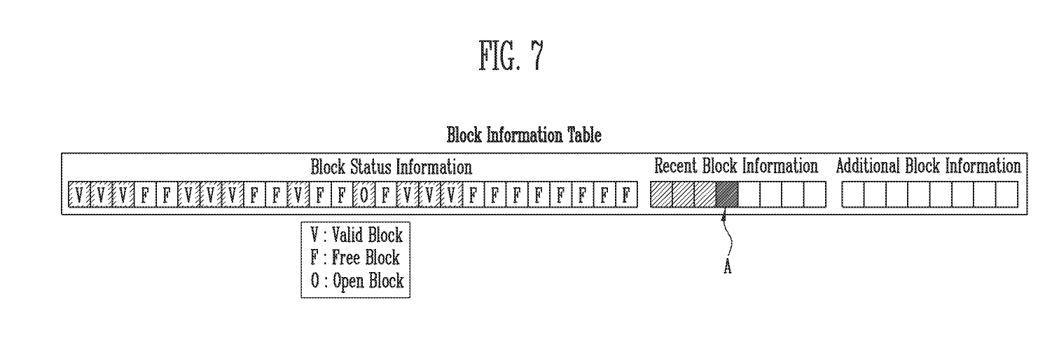

FIGS. 5 and 6 are flowcharts illustrating a method of operating the memory system 1000 in accordance with an embodiment of the present disclosure.

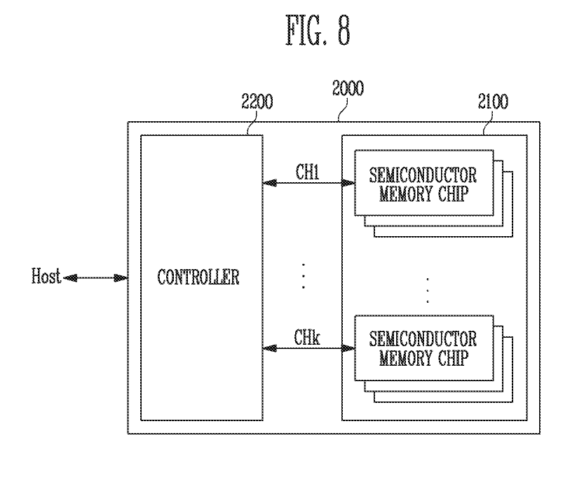

FIG. 7 is a diagram illustrating a block information table in accordance with an embodiment of the present disclosure.

The method of operating the memory system 1000 in accordance with an embodiment of the present disclosure will be described with reference to FIGS. 1 to 7.

In an embodiment of the present disclosure, a program operation for the overall operation of the semiconductor memory device 100 will be described by way of example.

The memory system 1000 may receive a program command, data, and a logical address from the host Host, at step S510.

At step S520, in response to the program command received from the host Host, the processing unit 1120 may select and allocate at least one free block among the memory blocks MB4 to MBm included in the memory cell array 110 of the semiconductor memory device 100 based on physical-logical address mapping information. The block status of the allocated free block may be changed to an open block status. The controller 1100 may determine, as the status update point, a point in time at which a new memory block is allocated or a point in time at which the new memory block is used, and control the semiconductor memory device 100 to store block information about the memory blocks MB4 to MBm included in the semiconductor memory device 100 into the first memory block MB1 or the second memory block MB2 of the block information storing block 111. The block information may be stored in the block information storing block 111 in a form of a table shown in FIG. 7. As shown in FIG. 7, the block information in the table (“Block Information Table”) may indicate whether the status of each memory block is a valid block, a free block or an open block (the region marked with “Block Status Information” in the table of FIG. 7), and also show information (marked with “A” in the region of “Recently Block Information” in the table of FIG. 7) about the currently selected block, and additional block information. The additional block information may include information about the most recently used memory block, a memory block to be used subsequent to the currently selected memory block, garbage collection victim block information, and so forth. The block information about the memory blocks MB4 to MBm that is stored in the first memory block MB1 or the second memory block MB2 may be copied and stored into the backup block MB3.

While storing the block information into the first memory block MB1 or the second memory block MB2 of the block information storing block 111, the semiconductor memory device 100 may select a page subsequent to a most recently programmed page and store the block information into the currently selected page in the first memory block MB1 or the second memory block MB2 of the block information storing block 111. At a subsequent status update point, a page subsequent to a most recently programmed page may be selected, and block information may be stored into the currently selected page in the first memory block MB1 or the second memory block MB2 of the block information storing block 111. In an embodiment, pages may be selected in a sequential order of their addresses in order to store the block information.

At step S530, the processing unit 1120 of the controller 1100 may control the semiconductor memory device 100 to perform a program operation on the allocated open block.

At step S540, during the program operation, a power loss may occur in the memory system 1000. If the power loss occurs in the memory system 1000, address mapping information, information about a current open block, victim block information, free block information, valid block information, information about a block to be erased, etc. may be lost.

Thereafter, power may be resupplied to the memory system 1000, in other words, a power-on operation may be performed, at step S550.

The controller 1100 may perform a recovery operation for recovering the memory system 1000 from the power loss during a booting process by the supply of the power.

At step S560, the controller 1100 may control the semiconductor memory device 100 to read the block information about the memory blocks MB4 to MBm stored in the first memory block MB1 or the second memory block MB2 included in the block information storing block 111 of the memory cell array 110. The read block information may be loaded onto the RAM 1110 of the controller 1100.

The processing unit 1120 of the controller 1100 may perform the recovery operation for recovering the memory system 1000 from the power loss, in other words, the power loss recovery operation, using the block information loaded onto the RAM1110.

Step S560 of reading the block information storing block 111 and step S570 of recovering the memory system 1000 from the power loss using the block information will be described in more detail with reference to FIG. 6.

During the read operation of step S560, the semiconductor memory device 100 may perform a scan operation on a memory block, in which the latest block information is stored between the first memory block MB1 and the second memory block MB2 included in the block information storing block 111, under control of the controller 1100, at step S561. The scan operation may include searching a most recently programmed page among the pages included in the first memory block MB1 or the second memory block MB2 in which the latest block information is stored. As described with reference to FIG. 2, at least two memory blocks (e.g., the first and second memory block MB1 and MB2) may be alternately used for updating and storing the block information. When one of the first and second memory block MB1 and MB2 is currently used for updating and storing the block information, the other one may be in the erased status. That is, the first and second memory block MB1 and MB2 may alternately become an open block and an erased block, and the open block between the first and second memory block MB1 and MB2 is currently used for updating and storing the block information. Therefore, the latest block information may be stored in the most recently programmed page in the open block between the first and second memory block MB1 and MB2.

The semiconductor memory device 100 may perform a read operation on the most recently programmed page detected through the scan operation and read data corresponding to the block information table from the detected page, at step S562. The read data corresponding to the read block information table may be stored into the RAM 1110 of the controller 1100.

The processing unit 1120 may generate a block list, an erase count, a read count, etc. using the read data corresponding to the block information table stored into the RAM1110, at step S571.

The block list may indicate respective current statuses of the memory blocks MB4 to MBm. For example, the block list may be generated to indicate whether each of the memory blocks MB4 to MBm is currently an open block, a free block, a valid block in which valid data is stored, or a block in which data is stored but is to be erased.

Furthermore, a most recently selected memory block, a memory block to be used subsequent to the currently selected memory block, and a garbage collection victim block may be generated as the block list using the data corresponding to the block information table.

At step S572, the processing unit 1120 may perform the recovery operation for recovering the memory system 1000 from the power loss, in other words, the power loss recovery operation, using the block list, the erase count, and the read count that have been generated. For example, latest address mapping information on which a map update operation has not been completed may be recovered using the information about the most recently selected block. Information about an open block that was used immediately before occurrence of the power loss may be recovered using the information about the block to be used subsequent to the current select block, and may be used when a new open block is allocated after the recovery operation for recovering from the power loss. Furthermore, the information about the garbage collection victim block may be used as information making it possible to rapidly perform a garbage collection operation while a victim block cannot be clearly searched for after the power loss has occurred. The free block may be rapidly secured by the rapid garbage collection operation.

As described above, in various embodiments of the present disclosure, at the status update point at which the statuses of memory blocks are changed during an operation of the memory system, information about the memory blocks may be stored into the block information storing block 111, and the power loss recovery operation may be performed using the information about the memory blocks that is stored in the block information storing block 111. Consequently, the speed of the power loss recovery operation may be improved.

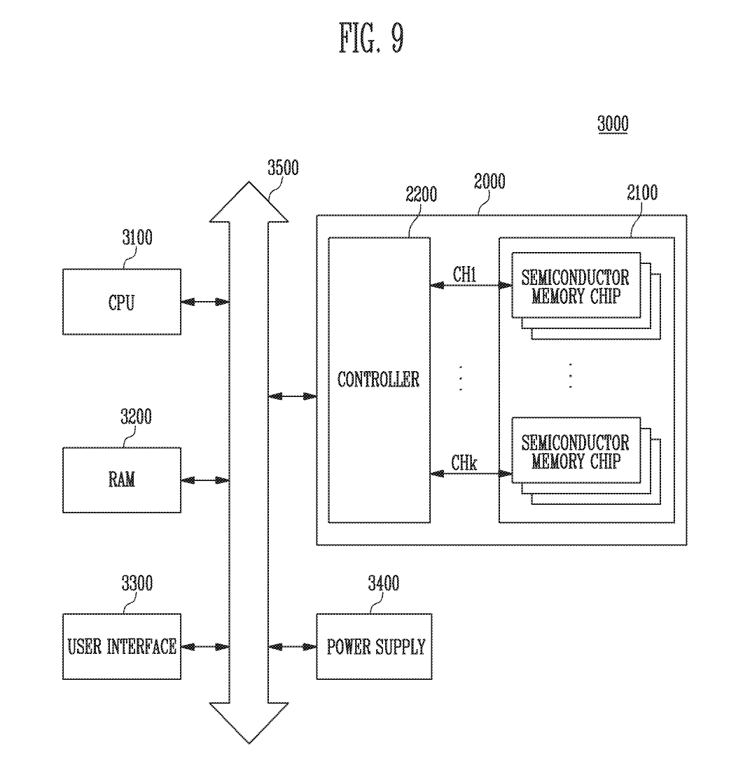

FIG. 8 is a block diagram illustrating an example of application of the memory system of FIG. 1.

Referring FIG. 8, a memory system 2000 may include a semiconductor memory device 2100 and a controller 2200. The semiconductor memory device 2100 includes a plurality of memory chips. The semiconductor memory chips may be divided into a plurality of groups.

In FIG. 8, it is illustrated that the plurality of groups respectively communicates with the controller 2200 through first to k-th channels CH1 to CHk. Each semiconductor memory chip may have the same configuration and operation as those of an embodiment of the semiconductor memory device 100 described with reference to FIG. 2.

Each group may communicate with the controller 2200 through one common channel. The controller 2200 has the same configuration as that of the controller 1100 described with reference to FIG. 1 and may control a plurality of memory chips of the semiconductor memory device 2100 through the plurality of channels CH1 to CHk.

FIG. 9 is a block diagram illustrating a computing system 3000 including the memory system described with reference to FIG. 8.

Referring to FIG. 9, the computing system 3000 may include a central processing unit 3100, a RAM 3200, a user interface 3300, a power supply 3400, a system bus 3500, and a memory system 2000.

The memory system 2000 may be electrically coupled to the CPU 3100, the RAM 3200, the user interface 3300, and the power supply 3400 through the system bus 3500. Data provided through the user interface 3300 or processed by the CPU 3100 may be stored in the memory system 2000.

In FIG. 9, the semiconductor memory device 2100 has been illustrated as being coupled to the system bus 3500 through the controller 2200. Furthermore, the semiconductor memory device 2100 may be directly coupled to the system bus 3500. The function of the controller 2200 may be performed by the CPU 3100 and the RAM 3200.

In FIG. 9, the memory system 2000 described with reference to FIG. 8 may be provided. In an embodiment, the memory system 2000 may be replaced with the memory system 1000 described with reference to FIG. 1. In an embodiment, the computing system 3000 may be formed of the memory systems 1000 and 2000 described with reference to FIGS. 1 and 8.

In various embodiments of the present disclosure, during an operation of the memory system, information about memory blocks may be stored to a block information storing block, and a power loss recovery operation may be performed using the information about the memory blocks that is stored in the block information storing block. Consequently, the speed of the power loss recovery operation may be improved.

Examples of embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A memory system comprising:
a semiconductor memory device including a plurality of memory blocks and a block information storing block; and
a controller configured to:
control the semiconductor memory device to store block information about the memory blocks into the block information storing block during an overall operation of the semiconductor memory device, and
perform, during a power loss recovery operation, a recovery operation using the block information stored in the block information storing block.

2. The memory system according to claim 1, wherein the block information storing block includes at least two memory blocks.

3. The memory system according to claim 2, wherein the block information is stored into a first memory block of the at least two memory blocks, and, when the first memory block lacks storage space, the block information is stored into a second memory block, and the first memory block is erased.

4. The memory system according to claim 2, wherein the block information storing block further includes a backup block.

5. The memory system according to claim 1, wherein the block information is updated at a status update point during the overall operation of the semiconductor memory device and stored into the block information storing block.

6. The memory system according to claim 5, wherein the status update point is a point in time at which a new memory block is allocated during the overall operation, or a point in time at which the new memory block is used.

7. The memory system according to claim 1, wherein the block information includes a block information table, wherein the block information table includes information indicating whether a status of each of the memory blocks is a valid block status, a free block status, or an open block status, information about a currently selected memory block, and additional block information.

8. The memory system according to claim 7, wherein the additional block information includes most recently used memory block information, information about a memory block to be used subsequent to the currently selected memory block, and garbage collection victim block information.

9. A memory system comprising:
a semiconductor memory device including a plurality of memory blocks and a block information storing block; and
a controller configured to control the semiconductor memory device to store block information about the memory blocks into the block information storing block at each of status update points at which statuses of the memory blocks are changed during an overall operation of the semiconductor memory device.

10. The memory system according to claim 9, wherein the controller performs, during a power loss recovery operation, a recovery operation using the block information stored in the block information storing block.

11. The memory system according to claim 9,
wherein the block information storing block includes at least two memory blocks, and
wherein the block information is stored into a first memory block of the at least two memory blocks, and, when the first memory block lacks storage space, the block information is stored into a second memory block, and the first memory block is erased.

12. The memory system according to claim 11, wherein the block information storing block further includes a backup block.

13. The memory system according to claim 11, wherein the block information is updated into the first memory block or the second memory block at each of the status update points, wherein the block information is stored into a page subsequent to a most recently programmed page of the first memory block or the second memory block.

14. The memory system according to claim 9, wherein the block information includes a block information table, and the block information table includes information indicating whether a status of each of the memory blocks is a valid block status, a free block status, or an open block status, information about a currently selected memory block, and additional block information.

15. The memory system according to claim 14, wherein the additional block information includes most recently used memory block information, information about a memory block to be used subsequent to the currently selected memory block, and garbage collection victim block information.

16. A method of operating a memory system, comprising:
performing an overall operation including a read operation, a write operation, and an erase operation of a semiconductor memory device including a plurality of memory blocks and a block information storing block;
updating and storing block information into the block information storing block at each of status update points during the overall operation;
reading latest block information stored in the block information storing block when a power-on operation is performed after a power loss; and
performing a power loss recovery operation using the read latest block information.

17. The method according to claim 16, wherein each status update point is a point in time at which a new memory block is allocated during the overall operation, or a point in time at which the new memory block is used.

18. The method according to claim 16, wherein the block information includes a block information table, wherein the block information table includes information indicating whether a status of each of the memory blocks is a valid block status, a free block status, or an open block status, information about a currently selected memory block, and additional block information.

19. The method according to claim 18, wherein the additional block information includes most recently used memory block information, information about a memory block to be used subsequent to the currently selected memory block, and garbage collection victim block information.

20. The method according to claim 19, wherein, during the power loss recovery operation,
latest address mapping information on which a map update operation has not been completed is recovered using information about the most recently selected block,
information about an open block that was used immediately before occurrence of the power loss is recovered using information about a block to be used subsequent to the current select block, and
the garbage collection victim block information is used as information enabling to perform garbage collection after the power loss.
